(19) United States
(12) Patent Application Publication
(10) Pub. No.: US 2019/0345899 A1
(43) Pub. Date: Nov. 14, 2019

(54) VAPORIZED-FUEL TREATING APPARATUS

(71) Applicant: AISAN KOGYO KABUSHIKI KAISHA, Obu-shi (JP)

(72) Inventor: Daisaku ASANUMA, Gamagori-shi (JP)

(73) Assignee: AISAN KOGYO KABUSHIKI KAISHA, Obu-shi (JP)

(21) Appl. No.: 16/377,289

(22) Filed: Apr. 8, 2019

(30) Foreign Application Priority Data
May 11, 2018 (JP) 2018-091871

(51) Int. Cl. F02M 25/08

(52) U.S. Cl. CPC F02M 25/0836; F02M 25/089

(57) ABSTRACT

A vaporized-fuel treating apparatus includes a canister, a vapor passage to direct vapor from a fuel tank to the canister, a purge passage to direct the vapor from the canister to an intake passage, a purge valve to open and close the purge passage, an atmospheric-air passage to draw atmospheric air into the canister, a purge pump provided in the atmospheric-air passage, and an ECU to control the purge valve, the purge pump, and others to purge the vapor from the canister. This apparatus includes a pressure limiting unit configured to limit the pressure downstream of the purge pump, the pressure acting on the fuel tank, from exceeding the withstanding pressure of the fuel tank while the ECU controls the purge valve and the purge pump to purge vapor from the canister to the intake passage.

### CROSS-REFERENCE TO RELATED APPLICATIONS

This application is based upon and claims the benefit of priority from the prior Japanese Patent Application No. 2018-091871 filed on May 11, 2018, the entire contents of which are incorporated herein by reference.

### BACKGROUND

### Technical Field

The present disclosure relates to a vaporized-fuel treating apparatus configured to process or treat vaporized fuel generated in a fuel tank.

### Related Art

As the above type of technique, conventionally, there has been known a vaporized-fuel treating apparatus disclosed in Japanese unexamined patent application publication No. 2004-68609 (JP 2004-68609A), for example. This apparatus includes a canister for collecting vaporized fuel (i.e., vapor) generated in a fuel tank, a purge passage for directing the vapor collected in the canister to an intake passage of an engine, a purge valve for opening/closing the purge passage, a purge pump for supplying pressurized air into the canister, a tank internal-pressure sensor for detecting the internal pressure of the fuel tank, and an electronic control unit (ECU) for controlling an operating state of the purge pump based on the internal pressure of the fuel tank. The ECU is configured to control the purge pump so that the internal pressure of the fuel tank is maintained at approximately atmospheric pressure.

### SUMMARY

### Technical Problem

In the apparatus disclosed in JP 2004-68609A, the pressure of vapor is controlled at approximately atmospheric pressure by the purge pump. However, when a negative pressure generated in the intake passage is low, limiting an amount of the vapor to be purged into the intake passage to a small amount, the vapor could not be sufficiently purged. In contrast, when the purge pump is operated at high rotation speed in order to sufficiently purge vapor, a piping system constituted of the purge passage, the canister, the fuel tank, and others may be subjected to excessive internal pressure. In particular, since the fuel tank is more deformable than other pipes, the internal pressure of the fuel tank needs to be controlled not to exceed a withstanding pressure of the fuel tank.

The present disclosure has been made to address the above problems and has a purpose to provide a vaporized-fuel treating apparatus in which a purge pump is provided in an atmospheric-air passage for drawing atmospheric air into a canister, the vaporized-fuel treating apparatus being configured to enhance the performance of purging vaporized fuel while preventing deformation of a fuel tank communicating with a downstream side of the purge pump due to internal pressure of the fuel tank.

### Means of Solving the Problem

To achieve the above-mentioned purpose, one aspect of the present disclosure provides a vaporized-fuel treating apparatus comprising: a canister configured to collect vaporized fuel generated in a fuel tank; a vaporized fuel passage configured to introduce the vaporized fuel from the fuel tank to the canister; a purge passage configured to direct and purge the vaporized fuel collected in the canister to an intake passage of an engine; a purge valve configured to open and close the purge passage; an atmospheric-air passage configured to draw atmospheric air into the canister; a purge pump provided in the atmospheric-air passage and configured to supply pressurized air to the canister; a controller configured to control at least the purge valve and the purge pump to purge the vaporized fuel from the canister to the intake passage; and a pressure limiting unit configured to limit pressure downstream of the purge pump, the pressure acting on the fuel tank, from exceeding withstanding pressure of the fuel tank while the controller controls the purge valve and the purge pump to purge the vaporized fuel from the canister to the intake passage.

According to the above aspect, in which the purge pump is provided in the atmospheric-air passage for drawing atmospheric air into the canister, it is possible to enhance the performance of purging vaporized fuel while preventing deformation of the fuel tank communicating with a downstream side of the purge pump due to internal pressure of the fuel tank.

### BRIEF DESCRIPTION OF THE DRAWING

FIG. 1 is a schematic diagram showing an engine system including a vaporized-fuel treating apparatus in a first embodiment;

FIG. 2 is a flowchart showing contents of pump downstream pressure control in the first embodiment;

FIG. 3 is a time chart showing one example of behaviors of various parameters associated with the above control in the first embodiment;

FIG. 4 is a schematic diagram showing an engine system including a vaporized-fuel treating apparatus in a second embodiment;

FIG. 5 is a flowchart showing contents of pump downstream pressure control in the second embodiment;

FIG. 6 is a time chart showing one example of behaviors of various parameters associated with the above control in the second embodiment;

FIG. 7 is a schematic diagram showing an engine system including a vaporized-fuel treating apparatus in a third embodiment;

FIG. 8 is a flowchart showing contents of pump downstream pressure control in the third embodiment;

FIG. 9 is a time chart showing one example of behaviors of various parameters associated with the above control in the third embodiment;

FIG. 10 is a schematic diagram showing an engine system including a vaporized-fuel treating apparatus in a fourth embodiment;

FIG. 11 is a flowchart showing contents of pump downstream pressure control in the fourth embodiment;

FIG. 12 is a time chart showing one example of behaviors of various parameters associated with the above control in the fourth embodiment;

FIG. 13 is a schematic diagram showing an engine system including a vaporized-fuel treating apparatus in a fifth embodiment;

FIG. 14 is a flowchart showing contents of pump downstream pressure control in the fifth embodiment; and

FIG. 15 is a time chart showing one example of behaviors of various parameters associated with the above control in the fifth embodiment.

### DETAILED DESCRIPTION OF THE EXEMPLARY EMBODIMENTS

### First Embodiment

A detailed description of a first embodiment of a vaporized-fuel treating apparatus which is one of typical embodiments of this disclosure will now be given referring to the accompanying drawings.

### (Outline of Engine System)

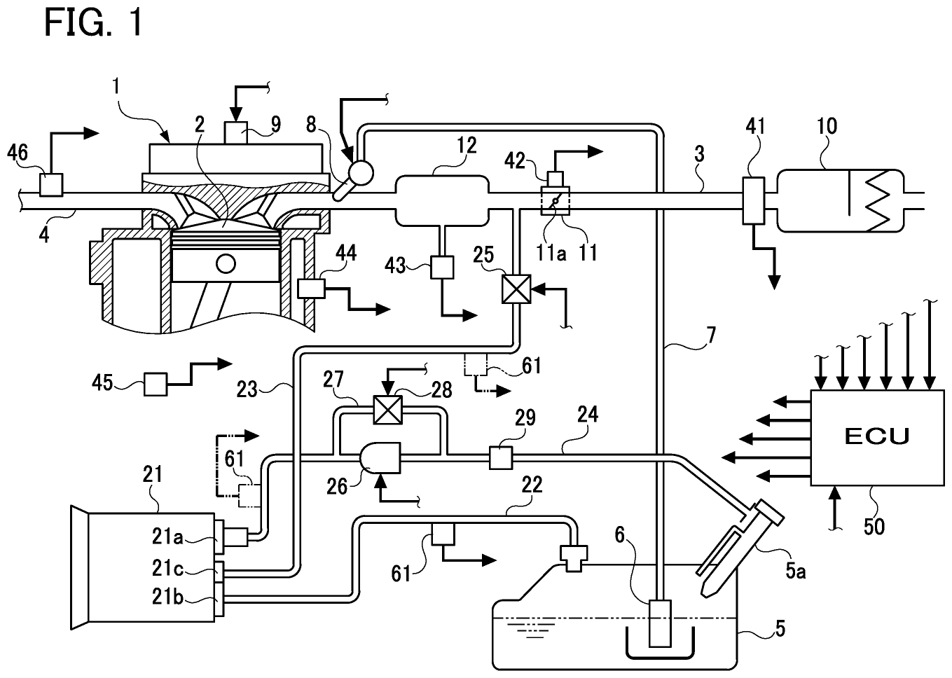

FIG. 1 is a schematic diagram showing an engine system including a vaporized-fuel treating apparatus mounted in a vehicle. An engine 1 is provided with an intake passage 3 configured to allow air and others to be sucked in a combustion chamber 2, and an exhaust passage 4 configured to discharge exhaust gas from the combustion chamber 2. The combustion chamber 2 is supplied with fuel stored in a fuel tank 5. That is, the fuel in the fuel tank 5 is ejected into a fuel passage 7 by a fuel pump 6 built in the fuel tank 5, and then delivered under pressure to an injector 8 provided in an intake port of the engine 1. The thus pressure-delivered fuel is injected from the injector 8 into the combustion chamber 2 along with air flowing through the intake passage 3, thereby forming a combustible air-fuel mixture which is subjected to combustion. The engine 1 is provided with an ignition device 9 for igniting the combustible air-fuel mixture.

In the intake passage 3, there are provided, from its entrance toward the engine 1, an air cleaner 10, a throttle device 11, and a surge tank 12. The throttle device 11 includes a throttle valve 11a which will be opened and closed to regulate an amount of intake air flowing through the intake passage 3. This opening/closing operation of the throttle valve 11a is interlocked with the operation of an accelerator pedal (not shown) by a driver. The surge tank 12 is configured to smoothen pulsation of intake air in the intake passage 3.

### (Structure of Vaporized-Fuel Treating Apparatus)

In FIG. 1, the vaporized-fuel treating apparatus in the present embodiment is configured to treat or process vaporized fuel (i.e., vapor) generated in the fuel tank 5 without releasing the vapor to atmosphere. Specifically, this apparatus includes a canister 21 configured to collect vapor generated in the fuel tank 5, a vapor passage 22 configured to introduce vapor from the fuel tank 5 to the canister 21, a purge passage 23 configured to direct and purge the vapor collected by the canister 21 to the intake passage 3, an atmospheric-air passage 24 configured to draw atmospheric air into the internal space of the canister 21, a purge valve 25 configured to open and close the purge passage 23 in order to regulate a purge flow rate of vapor, and a purge pump 26 placed in the atmospheric-air passage 24 and configured to supply pressurized air to the canister 21 to deliver vapor under pressure from the canister 21 to the purge passage 23.

The canister 21 internally contains an adsorbent, such as active carbon. The canister 21 includes an air inlet port 21a through which atmospheric air flows in, an inlet port 21b through which vapor flows in the canister 21, and an outlet port 21c through which vapor is discharged from the canister 21. A distal end of the atmospheric-air passage 24 extending from the air inlet 21a communicates with an oil filler pipe 5a of the fuel tank 5. At some place in the atmospheric-air passage 24, a bypass passage 27 is provided to detour around the purge pump 26. In this bypass passage 27, a bypass valve 28 is provided to open and close the bypass passage 27. Further, a filter 29 is placed in the atmospheric-air passage 24 upstream of the purge pump 26 and the bypass valve 28 to collect powder dust and others in the air. A distal end of the vapor passage 22 extending from the inlet port 21b of the canister 21 communicates with the inside of the fuel tank 5. A distal end of the purge passage 23 extending from the outlet port 21c of the canister 21 communicates with the intake passage 3 located between the throttle device 11 and the surge tank 12.

In the present embodiment, the purge valve 25 consists of an electric-operated valve (VSV) and is configured to change an opening degree in order to regulate a vapor flow rate. The purge pump 26 is motor-driven and configured to change an air ejection pressure. As the purge pump 26, for example, a turbine pump may be adopted. The bypass valve 28 consists of an electric-operated valve and is configured to open and close the bypass passage 27.

The vaporized-fuel treating apparatus configured as above is operative to introduce vapor generated in the fuel tank 5 into the canister 21 through the vapor passage 22 and collect once the vapor in the canister 21. Then, during operation of the engine 1, the throttle device 11 (i.e., the throttle valve 11a) is opened, the purge valve 25 is opened, and the purge pump 26 is operated. Accordingly, the vapor collected in the canister 21 is purged from the canister 21 into the intake passage 3 through the purge passage 23.

### (Electric Structure of Engine System)

In the present embodiment, various sensors 41 to 46 and others are provided. An airflow meter 41 provided near the air cleaner 10 is configured to detect the amount of air to be sucked in the intake passage 3 as an intake amount and output an electric signal representing a detection value thereof. A throttle sensor 42 provided in the throttle device 11 is configured to detect the opening degree of the throttle valve 11a as a throttle opening degree and output an electric signal representing a detection value thereof. An intake pressure sensor 43 provided in the surge tank 12 and configured to detect the internal pressure of the surge tank 12 as an intake pressure and output an electric signal representing a detection value thereof. A water temperature sensor 44 provided in the engine 1 and configured to detect the temperature of cooling water flowing through the inside of the engine 1 as a cooling-water temperature and output an electric signal representing a detection value thereof. A rotation number sensor 45 provided in the engine 1 and configured to detect the number of rotations of a crank shaft (not shown) of the engine 1 per unit of time as an engine rotation number NE and output an electric signal representing a detection value thereof. An oxygen sensor 46 provided in the exhaust passage 4 and configured to detect the oxygen concentration of exhaust gas and output an electric signal representing a detection value thereof.

In the present embodiment, furthermore, a pump downstream pressure sensor 61 is provided to detect the pressure PP in the atmospheric-air passage 24 on a downstream side of the purge pump 26 (i.e., pump downstream pressure). This pump downstream pressure sensor 61 corresponds to one example of a pump downstream pressure detecting unit in the present disclosure. In the present embodiment, the pump downstream pressure sensor 61 is provided in the vapor passage 22 as indicated by a solid line in FIG. 1. As alternatives, the pump downstream pressure sensor 61 may be provided in the atmospheric-air passage 24 or the purge passage 23 as indicated by two-dot chain lines in FIG. 1.

In the present embodiment, an electronic control unit (ECU) 50 responsible for various controls receives various signals output from various sensors 41 to 46 and others. The ECU 50 is configured to control the injector 8, the ignition device 9, the purge valve 25, the purge pump 26, and the bypass valve 28 based on the input signals to execute fuel injection control, ignition timing control, purge control, and pump downstream pressure control.

Herein, the fuel injection control is to control the injector 8 according to an operating state of the engine 1 to control a fuel injection amount and a fuel injection timing. The ignition timing control is to control the ignition device 9 according to an operating state of the engine 1 to control an ignition timing of combustible air-fuel mixture. The purge control is to control the purge valve 25 and the purge pump 26 according to an operating state of the engine 1 to regulate a purge flow rate of vapor from the canister 21 to the intake passage 3. Further, the pump downstream pressure control is to control the purge pump 26 and the bypass valve 28 according to an operating state of the engine 1 to control the pump downstream pressure PP.

In the present embodiment, the ECU 50 is provided with a well-known structure including a central processing unit (CPU), a read only memory (ROM), a random-access memory (RAM), a backup RAM, and others. The ROM stores in advance predetermined control programs related to the foregoing various controls. The ECU (CPU) 50 is configured to execute the foregoing various controls according to those control programs.

In the structure mentioned above, as one example, the ECU 50, the bypass passage 27, the bypass valve 28, and the pump downstream pressure sensor 61 constitute a pressure limiting unit in the present disclosure.

In the present embodiment, for the fuel injection control, the ignition timing control, and the purge control. well-known contents are adopted. Only the pump downstream pressure control will be described below in detail.

### (Pump Downstream Pressure Control)

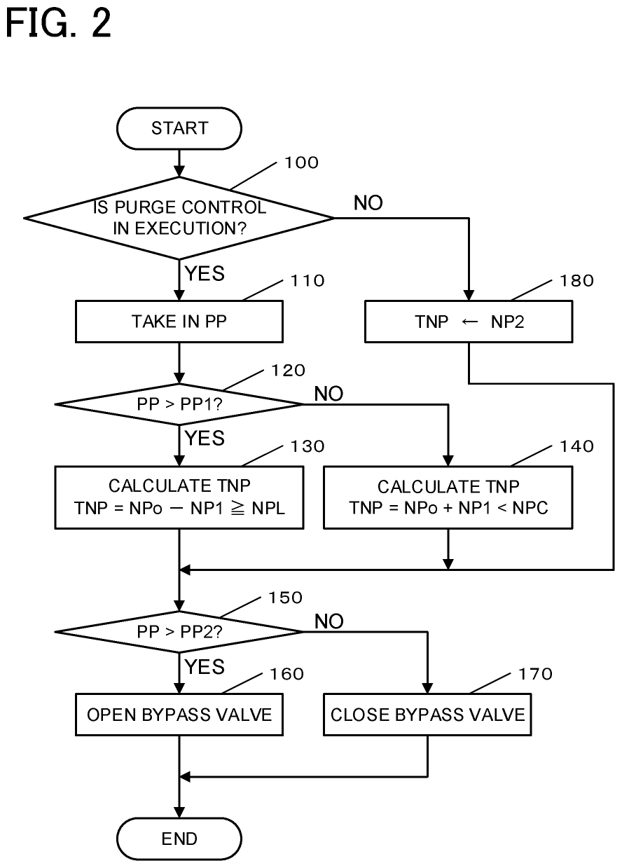

Next, the pump downstream pressure control is described. FIG. 2 is a flowchart showing the contents of this control. The ECU 50 executes this routine periodically at predetermined time intervals.

When the processing enters this routine, in step 100, the ECU 50 determines whether or not the purge control is in execution. If a determination result in this step is affirmative (YES in step 100), the ECU 50 advances the processing to step 110. On the other hand, if this determination result is negative (NO in step 100), the ECU 50 shifts the processing to step 180.

In step 110, the ECU 50 takes in the pump downstream pressure PP. The ECU 50 can take in this pump downstream pressure PP from a detection value of the pump downstream pressure sensor 61.

In step 120, subsequently, the ECU 50 determines whether or not the pump downstream pressure PP is larger than a first predetermined value PP1 (e.g., PP1=8 kPa). If YES in step 120, the ECU 50 advances the processing to step 130. If NO in step 120, the ECU 50 shifts the processing to step 140.

In step 130, the ECU 50 calculates a target pump rotation number TNP representing the target number of rotations of the purge pump 26. In this case, the ECU 50 can calculate this target pump rotation number TNP equal to or larger than a lower-limit pump rotation number NPL by subtracting a first predetermined value NP1 (e.g., NP1=50 rpm) from a previous pump rotation number NPo. This target pump rotation number TNP is reflected, or used, in the control of the purge pump 26 in the purge control.

In step 140, the ECU 50 similarly calculates a target pump rotation number TNP. In this case, the ECU 50 can calculate this target pump rotation number TNP less than an upper-limit pump rotation number NPC by adding the first predetermined value NP1 (e.g., NP1=50 rpm) to the previous pump rotation number NPo. This target pump rotation number TNP is reflected, or used, in the control of the purge pump 26 in the purge control.

In step 180, on the other hand, the ECU 50 sets a second predetermined value NP2 (e.g., 10000 rpm) as the target pump rotation number TNP. This target pump rotation number TNP is also reflected, or used, in the control of the purge pump 26 in the purge control.

In step 150, following step 130, step 140, or step 180, the ECU 50 determines whether or not the pump downstream pressure PP is larger than the second predetermined value PP2 (e.g., PP2=10 kPa, PA2>PP1). If YES in step 150, the ECU 50 advances the processing to step 160. If NO in step 150, the ECU 50 shifts the processing to step 170.

In step 160, the ECU 50 causes the bypass valve 28 to open and temporarily stops subsequent processing. Accordingly, even if the purge pump 26 is poor in control responsiveness, the bypass passage 27 (i.e., an upstream side of the bypass valve 28) immediately communicates with the atmospheric-air passage 24 (i.e., a downstream side of the purge pump 26) and thus the pump downstream pressure PP is reduced with good responsiveness. That is, the pump downstream pressure PP is depressed rapidly.

In step 170, on the other hand, the ECU 50 causes the bypass valve 28 to close and temporarily stops subsequent processing. In this case, since the bypass passage 27 (i.e., the upstream side of the bypass valve 28) does not communicate with the atmospheric-air passage 24 (i.e., the downstream side of the purge pump 26) and thus the pump downstream pressure PP is maintained.

According to the foregoing control, the ECU 50 is configured to control the number of rotations of the purge pump 26 (i.e., the pump rotation number NP) to prevent the detected pressure downstream of the purge pump 26 (i.e., the pump downstream pressure PP) from exceeding the withstanding pressure of the fuel tank 5. Further, the ECU 50 is also configured to cause the bypass valve 28 to open when the detected pump downstream pressure PP exceeds the withstanding pressure of the fuel tank 5. Specifically, the aforementioned structure is configured such that while the ECU 50 controls the purge valve 25 and the purge pump 26 to purge vapor from the canister 21 to the intake passage 3, the ECU 50 limits the pump downstream pressure PP acting on the fuel tank 5 so as not to exceed the withstanding pressure of the fuel tank 5.

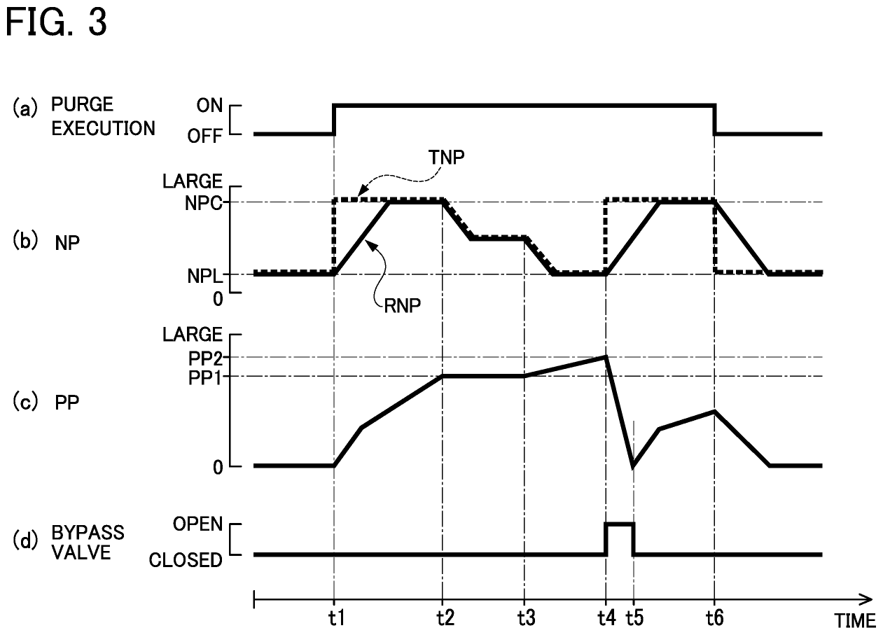

Herein, FIG. 3 is a time chart showing one example of behaviors of various parameters related to the foregoing control. In FIG. 3, a graph (a) indicates execution of purge control (hereinafter referred to as “purge execution”), a graph (b) plots the pump rotation number NP, a graph (c) shows the pump downstream pressure PP, and a graph (d) denotes an open/closed state of the bypass valve 28. In the graph (b) of FIG. 3, a thick line indicates an actual pump rotation number RNP representing the actually detected number of rotations of the purge pump 26 and a thick broken line indicates the target pump rotation number TNP representing the target number of rotations of the purge pump 26.

In FIG. 3, when the purge execution is started, that is, from OFF to ON, at time t1 as shown in the graph (a), the pump rotation number NP (both the actual pump rotation number RNP and the target pump rotation number TNP) increases as shown in the graph (b). Herein, the target pump rotation number TNP rises from the lower-limit pump rotation number NPL to the upper-limit pump rotation number NPC. The actual pump rotation number RNP starts to increase from the lower-limit pump rotation number NPL to the upper-limit pump rotation number NPC. Along with this, the pump downstream pressure PP starts to increase as shown in the graph (c). Thereafter, when the pump downstream pressure PP reaches the first predetermined value PP1 at time t2 as shown in the graph (c), the pump rotation number NP (both the actual pump rotation number RNP and the target pump rotation number TNP) starts to decrease. Subsequently, at time 3, the pump rotation number NP (both the actual pump rotation number RNP and the target pump rotation number TNP) starts to further decrease as shown in the graph (b), whereas the pump downstream pressure PP starts to increase as shown in the graph (c). When the pump downstream pressure PP reaches the second predetermined value PP2 at time t4, the bypass valve 28 is opened for a period from time t4 to time t5 as shown in the graph (d). Along with this, the pump downstream pressure PP sharply decreases during the period from time t4 to time t5 as shown in the graph (c). Accordingly, even when the pump rotation number NP (both the actual pump rotation number RNP and the target pump rotation number TNP) is increased again at time t4 to the upper-limit pump rotation number NPC as shown in the graph (b), an increase in the pump downstream pressure PP is suppressed to a lower level than the first predetermined value PP1 during a period from time t5 to time t6 as shown in the graph (c). Therefore, when the pump downstream pressure PP reaches the second predetermined value PP2 even though the pump rotation number NP is reduced, the bypass valve 28 is opened, thereby enabling large reduction in the pump downstream pressure PP, so that the internal pressure acting on the fuel tank 5 can be reduced.

### (Operations and Effects of Vaporized-Fuel Treating Apparatus)

According to the vaporized-fuel treating apparatus in the present embodiment described above, while the purge valve 25 and the purge pump 26 are controlled to purge vapor from the canister 21 to the intake passage 3, the pressure on a downstream side of the purge pump 26 (i.e., the pump downstream pressure PP) is limited by the pressure limiting unit so as not to exceed the withstanding pressure of the fuel tank 5.

Herein, the pressure limiting unit consists of the ECU 50, the bypass passage 27, the bypass valve 28, and the pump downstream pressure sensor 61. Since the number of rotations of the purge pump 26 (i.e., the pump rotation number NP) is controlled to prevent the detected pump downstream pressure PP from exceeding the withstanding pressure of the fuel tank 5 (which is larger than the first predetermined value PP1), the internal pressure of the fuel tank 5 is limited from exceeding the withstanding pressure of the fuel tank 5. The vaporized-fuel treating apparatus in which the purge pump 26 is provided in the atmospheric-air passage 24 for drawing atmospheric air into the canister 21 can therefore enhance the performance of purging vapor while preventing deformation of the fuel tank 5 communicating with the downstream side of the purge pump 26 due to the internal pressure of the fuel tank 5. In other words, both effects; prevention of deformation of the fuel tank 5 due to internal pressure thereof and enhancement of vapor purging performance can be satisfied.

According to the structure in the present embodiment, furthermore, when the detected pump downstream pressure PP exceeds the withstanding pressure of the fuel tank 5, the bypass valve 28 is opened. Thus, the pump downstream pressure PP is released to atmosphere through the bypass passage 27, so that the pump downstream pressure PP that exceeds the withstanding pressure of the fuel tank 5 is promptly reduced. Accordingly, even when the purge pump 26 is poor in responsiveness and the pump rotation number NP does not rapidly decrease, the fuel tank 5 can be surely prevented from deforming due to internal pressure thereof.

### Second Embodiment

Next, a second embodiment of the vaporized-fuel treating apparatus will be described referring to the accompanying drawings.

In the following description, similar or identical parts to those in the first embodiment are given the same references as those in the first embodiment and their details are not repeated herein. Thus, the following description is made with a focus on differences from the first embodiment.

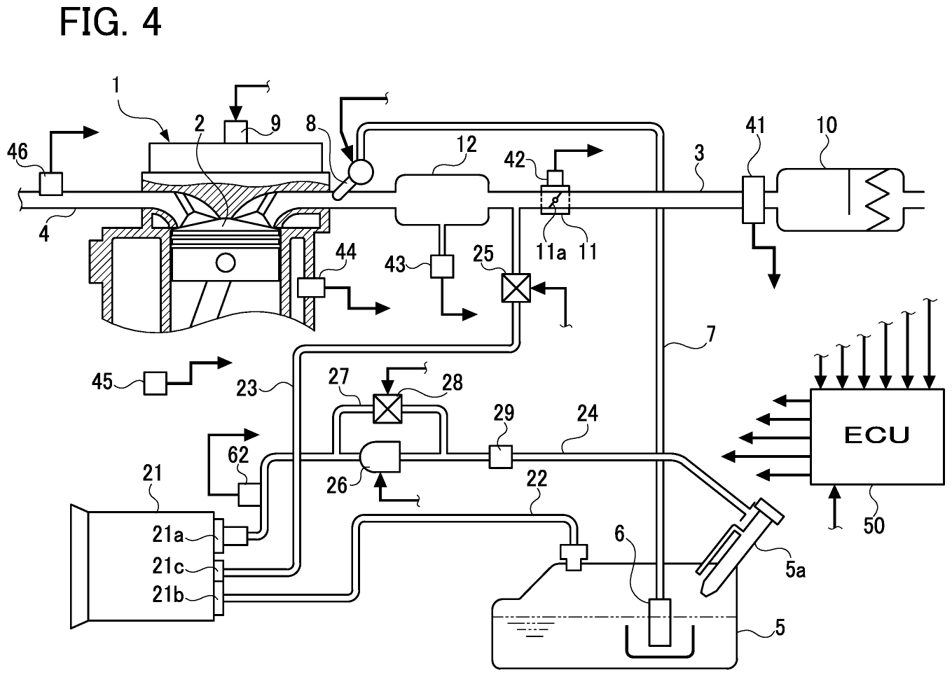

The present embodiment differs from the first embodiment in the structure of the vaporized-fuel treating apparatus and the contents of pump downstream pressure control. FIG. 4 is a schematic diagram showing an engine system including the vaporized-fuel treating apparatus in the present embodiment. In this embodiment, instead of the pump downstream pressure sensor 61, a vapor temperature sensor 62 is provided to detect the temperature of vapor (i.e., a vapor temperature) THvp. This vapor temperature sensor 62 is placed in the atmospheric-air passage 24 downstream of the purge pump 26 and the bypass valve 28. Other structures of the vaporized-fuel treating apparatus are identical to those in the first embodiment.

In the present embodiment, as one example, the ECU 50, the bypass passage 27, the bypass valve 28, the airflow meter 41, the intake pressure sensor 43, and the vapor temperature sensor 62 constitute a pressure limiting unit in the present disclosure. The vapor temperature sensor 62 corresponds to one example of a vaporized fuel temperature detecting unit in the present disclosure. The intake pressure sensor 43 and the vapor temperature sensor 62 correspond to one example of an operating state detecting unit in the present disclosure. The same applies to the following description.

### (Pump Downstream Pressure Control)

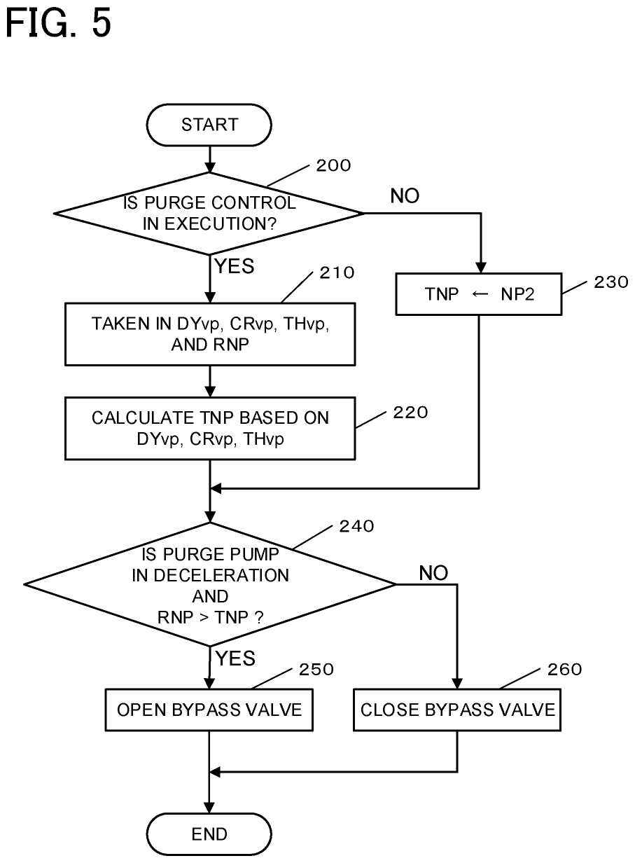

The pump downstream pressure control will be described below. FIG. 5 is a flowchart showing contents of this control. The ECU 50 executes this routine periodically at predetermined time intervals.

When the processing enters this routine, in step 200, the ECU 50 determines whether or not the purge control is in execution. If YES in step 200, the ECU 50 advances the processing to step 210. If NO in step 200, the ECU 50 moves the processing to step 230.

In step 210, the ECU 50 takes in a controlled opening degree DYvp of the purge valve 25, a vapor concentration CRvp, a vapor temperature THvp, and an actual pump rotation number RNP of the purge pump 26. The ECU 50 can calculate the vapor concentration CRvp based on a deviation of a well-known air-fuel ratio feedback correction value calculated from an oxygen concentration Ox detected by the oxygen sensor 46, and others. This calculation method will not be elaborated upon here.

In step 220, the ECU 50 calculates a target pump rotation number TNP based on the controlled opening degree DYvp, the vapor concentration CRvp, and the vapor temperature THvp by referring to a three-dimensional map that has been set in advance. This target pump rotation number TNP is reflected, or used, in the control of the purge pump 26 in the purge control.

In step 230, on the other hand, the ECU 50 sets a second predetermined value NP2 (e.g., 10000 rpm) as the target pump rotation number TNP. This target pump rotation number is also reflected, or used, in the control of the purge pump 26 in the purge control.

In step 240 following step 220 or step 230, successively, the ECU 50 determines whether or not the purge pump 26 is in deceleration and the actual pump rotation number RNP is larger than the target pump rotation number TNP. In other words, in step 240, it is determined whether or not both the above two conditions are satisfied. If YES in step 240, the ECU 50 advances the processing to step 250. If NO in step 240, the ECU 50 moves the processing to step 260.

In step 250, the ECU 50 causes the bypass valve 28 to open and temporarily stops subsequent processing. Accordingly, even if the purge pump 26 is poor in control responsiveness, the bypass passage 27 (i.e., an upstream side of the bypass valve 28) immediately communicates with the atmospheric-air passage 24 (i.e., a downstream side of the purge pump 26) and thus the pump downstream pressure PP is reduced with good responsiveness. That is, the pump downstream pressure PP is depressed rapidly.

In step 260, on the other hand, the ECU 50 causes the bypass valve 28 to close and temporarily stops subsequent processing. In this case, since the bypass passage 27 does not communicate with the atmospheric-air passage 24 and thus the pump downstream pressure PP is maintained.

According to the foregoing control, different from the control in the first embodiment, the ECU 50 is configured to calculate the vapor concentration (i.e., the purge air-fuel ratio) CRvp based on a deviation of an air-fuel ratio feedback correction value calculated from an oxygen concentration Ox detected by the oxygen sensor 46, and others, and also calculate the target pump rotation number TNP of the purge pump 26 based on the calculated vapor concentration CRvp, the controlled opening degree DYvp of the purge valve 25 that is currently controlled, and the detected vapor temperature THvp. Accordingly, when the purge pump 26 is in deceleration and the actual pump rotation number RNP of the purge pump 26 is larger than the calculated target pump rotation number TNP, the ECU 50 causes the bypass valve 28 to open.

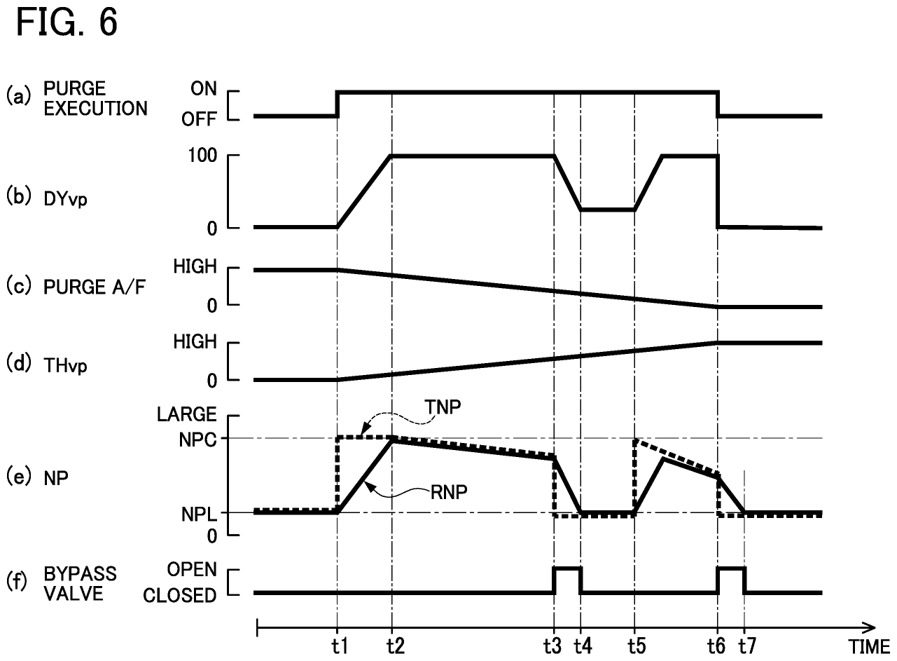

Herein, FIG. 6 is a flowchart showing one example of behaviors of various parameters related to the foregoing control. In FIG. 6, a graph (a) indicates purge execution, a graph (b) plots the controlled opening degree DYvp of the purge valve 25, a graph (c) shows a purge air-fuel ratio (A/F), a graph (d) denotes the vapor temperature THvp, a graph (e) shows the pump rotation number NP, and a graph (f) denotes an open/closed state of the bypass valve 28. In the graph (e) of FIG. 6, a thick line indicates the actual pump rotation number RNP and a thick broken line indicates the target pump rotation number TNP.

In FIG. 6, when the purge execution is started at time t1 as shown in the graph (a), the controlled opening degree DYvp of the purge valve 25 starts to increase toward a full open degree (100%) as shown in the graph (b), the purge A/F starts to decrease as shown in the graph (c), the vapor temperature THvp starts to increase as shown in the graph (d), and the pump rotation number NP (both the actual pump rotation number RNP and the target pump rotation number TNP) increases as shown in the graph (e).

Thereafter, when the controlled opening degree DYvp reaches 100% (the full open degree) at time t2 as shown in the graph (b), the pump rotation number NP (both the actual pump rotation number RNP and the target pump rotation number TNP) starts to decrease, or decelerate, as shown in the graph (e). Subsequently, at time t3, when the controlled opening degree DYvp starts to decrease as shown in the graph (b), the pump rotation number NP (both the actual pump rotation number RNP and the target pump rotation number TNP) decreases as shown in the graph (e). At that time, the target pump rotation number TNP drops sharply to the lower-limit pump rotation number NPL and the actual pump rotation number RNP starts to decrease toward the lower-limit pump rotation number NPL. Thus, during a period from time t3 to time t4, the actual pump rotation number RNP decreases slower than the target pump rotation number TNP, so that the bypass valve 28 is opened for this period.

Thereafter, at time t5, when the controlled opening degree DYvp starts to increase to the full open degree (100%) as shown in the graph (b), the pump rotation number NP (both the actual pump rotation number RNP and the target pump rotation number TNP) increases as shown in the graph (e). Subsequently, at time t6, when the purge execution is terminated, that is, from ON to OFF, as shown in the graph (a) and the controlled opening degree DYvp becomes 0% as shown in the graph (b), the pump rotation number NP (both the actual pump rotation number RNP and the target pump rotation number TNP) decreases as shown in the graph (e). At that time, similarly, the actual pump rotation number RNP decreases slower than the target pump rotation number TNP during a period from time t6 to time t7, so that the bypass valve 28 is opened for this period. Thus, when the actual pump rotation number RNP only decreases slowly even though the target pump rotation number TNP is sharply decreased, the bypass valve 28 is caused to open, thereby enabling large reduction in the pump downstream pressure PP, so that the internal pressure acting on the fuel tank 5 can be reduced.

### (Operations and Effects of Vaporized-Fuel Treating Apparatus)

According to the vaporized-fuel treating apparatus in the present embodiment described above, the following operations and effects can be obtained, differently from those in the first embodiments. Specifically, the vapor concentration CRvp is calculated based on a detected operating state (i.e., a detection value of the oxygen sensor 46) and also the target pump rotation number TNP is calculated based on the calculated vapor concentration CRvp, the controlled opening degree DYvp of the purge valve 25 being currently controlled, and the detected vapor temperature THvp. Furthermore, when the purge pump 26 is in deceleration and the actual pump rotation number RNP of the purge pump 26 is larger than the calculated target pump rotation number TNP, the bypass valve 28 is opened, thereby limiting the pump downstream pressure PP so as not to exceed the withstanding pressure of the fuel tank 5. Accordingly, even when the purge pump 26 is poor in responsiveness and the pump rotation number NP does not rapidly decrease, the fuel tank 5 can be surely prevented from deforming due to internal pressure thereof.

### Third Embodiment

Next, a third embodiment of the vaporized-fuel treating apparatus will be described referring to the accompanying drawings.

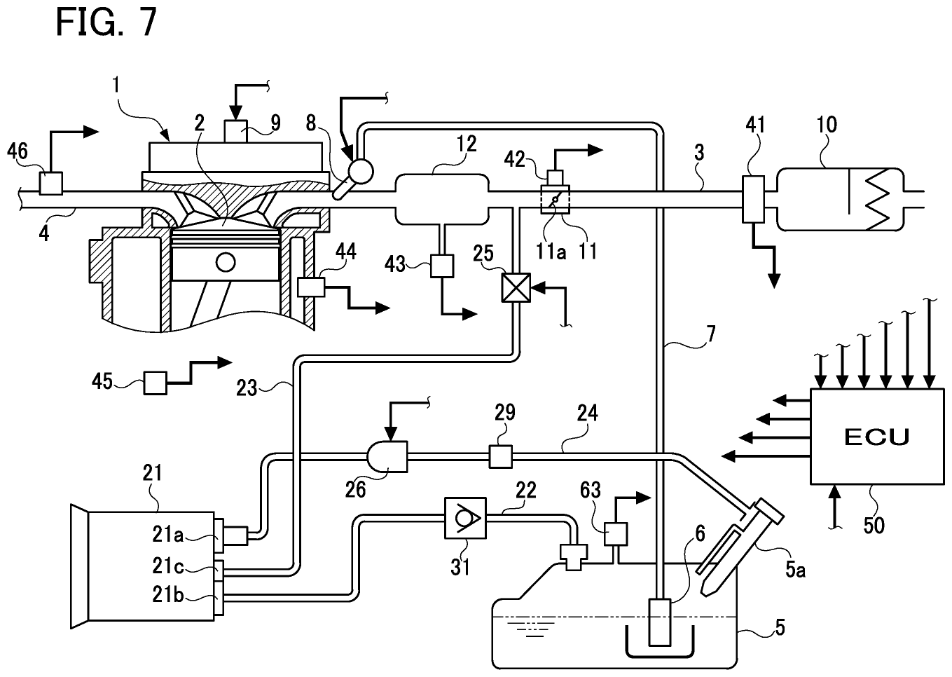

The present embodiment differs from each of the foregoing embodiments in the structure of the vaporized-fuel treating apparatus and the contents of pump downstream pressure control. FIG. 7 is a schematic diagram showing an engine system including the vaporized-fuel treating apparatus in the present embodiment. In this embodiment, only the purge pump 26 and the filter 29 are provided in the atmospheric-air passage 24, and a check valve 31 is provided in the vapor passage 22. In the fuel tank 5, a tank internal pressure sensor 63 is provided to detect the internal pressure of the fuel tank 5 (i.e., tank internal pressure) PT. The check valve 31 allows a flow of gas from the fuel tank 5 to the canister 21 and blocks a flow of gas from the canister 21 to the fuel tank 5. Other structures of the vaporized-fuel treating apparatus are identical to those in the foregoing embodiments.

In the present embodiment, as one example, the ECU 50, the tank internal pressure sensor 63, and the check valve 31 constitute a pressure limiting unit in the present disclosure. The tank internal pressure sensor 63 corresponds to one example of a tank internal pressure detecting unit in the present disclosure.

### (Pump Downstream Pressure Control)

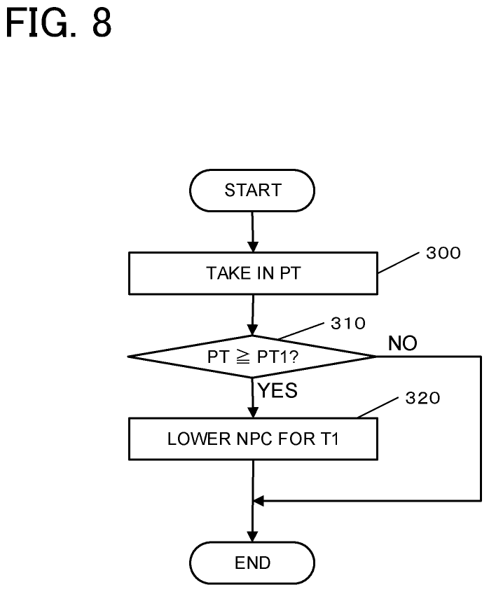

The pump downstream pressure control will be described below. FIG. 8 is a flowchart showing contents of this control. The ECU 50 executes this routine periodically at predetermined time intervals.

When the processing enters this routine, in step 300, the ECU 50 takes in a tank internal pressure PT from a detection value of the tank internal pressure sensor 63.

In step 310, the ECU 50 determines whether or not the tank internal pressure PT is equal to or larger than a predetermined value PT1 (e.g., 10 kPa). This predetermined value PT1 corresponds to the withstanding pressure of the fuel tank 5. If YES in step 310, the ECU 50 advances the processing to step 320. If NO in step 310, the ECU 50 temporarily stops subsequent processing.

In step 320, the ECU 50 lowers the upper-limit pump rotation number NPC for a predetermined period T1 (e.g., 10 seconds). The ECU 50 can lower the upper-limit pump rotation number NPC for example from 50000 rpm to 20000 rpm. Then, the ECU 50 temporarily stops the processing.

According to the foregoing control, when the detected tank internal pressure PT reaches or is about to exceed the withstanding pressure of the fuel tank 5, the ECU 50 reduces the number of rotations of the purge pump 26 for the predetermined period T1. Specifically, when the tank internal pressure PT is about to exceed the predetermined value PT1, the ECU 50 lowers the upper-limit pump rotation number NPC for the predetermined period T1, thereby decreasing the pump downstream pressure PP to depressurize the fuel tank 5. Further, since the check valve 31 is provided in the vapor passage 22, the tank internal pressure PT is prevented from increasing even if the pump downstream pressure PP rises. Specifically, the aforementioned structure is configured such that while the ECU 50 controls the purge valve 25 and the purge pump 26, the ECU 50 limits the pump downstream pressure PP acting on the fuel tank 5 from exceeding the withstanding pressure of the fuel tank 5.

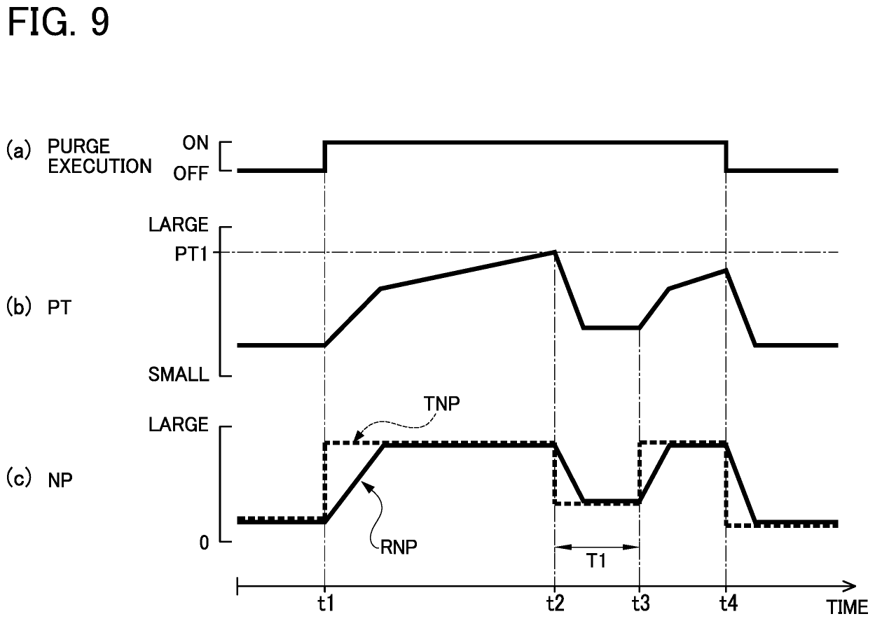

Herein, FIG. 9 is a time chart showing one example of behaviors of various parameters related to the foregoing control. In FIG. 9, a graph (a) indicates purge execution, a graph (b) plots the tank internal pressure PT, and a graph (c) shows the pump rotation number NP. In the graph (c) of FIG. 9, a thick line indicates an actual pump rotation number RNP and a thick broken line indicates the target pump rotation number TNP.

In FIG. 9, when the purge execution is started at time t1 as shown in the graph (a), the pump rotation number NP (both the actual pump rotation number RNP and the target pump rotation number TNP) increases. Herein, the target pump rotation number TNP rises from a lower-limit pump rotation number NPL to an upper-limit pump rotation number NPC and the actual pump rotation number RNP starts to increase from the lower-limit pump rotation number NPL toward the upper-limit pump rotation number NPC. Along with this, the tank internal pressure PT starts to increase as shown in the graph (b). Then, when the tank internal pressure PT reaches a predetermined value PT1 at time t2, the pump rotation number NP (both the actual pump rotation number RNP and the target pump rotation number TNP) decreases. Subsequently, after a predetermined period T1 has elapsed, the pump rotation number NP (both the actual pump rotation number RNP and the target pump rotation number TNP) increases again from time t3 as shown in the graph (c). However, this increase in the tank internal pressure PT is suppressed to a lower level than the predetermined value PT1 for a period from time t3 to time t4 as shown in the graph (b). Accordingly, when the tank internal pressure PT reaches the predetermined value PT1, the number of rotations of the purge pump 26 is reduced once, so that the tank internal pressure can be reduced.

### (Operations and Effects of Vaporized-Fuel Treating Apparatus)

According to the vaporized-fuel treating apparatus in the present embodiment described above, when the detected tank internal pressure PT is about to excess the withstanding pressure of the fuel tank 5, the number of rotations of the purge pump 26 (i.e., the pump rotation number NP) is reduced. Thus, the pump downstream pressure PP is limited from exceeding the withstanding pressure of the fuel tank 5. Consequently, the vaporized-fuel treating apparatus in which the purge pump 26 is provided in the atmospheric-air passage 24 for drawing atmospheric air into the canister 21 can enhance the performance of purging vapor while preventing deformation of the fuel tank 5 communicating with the downstream side of the purge pump 26 due to the internal pressure of the fuel tank 5. In other words, both effects; prevention of deformation of the fuel tank 5 due to internal pressure thereof and enhancement of vapor purging performance can be satisfied.

According to the structure in the present embodiment, furthermore, even when the pump downstream pressure PP is excessive, such a pressure is limited by the check valve 31 from acting on the fuel tank 5. Thus, the vaporized-fuel treating apparatus can increase the pressure in a piping system communicating with the downstream side of the purge pump 26 without causing deformation of the fuel tank 5 due to internal pressure thereof and thus enhance the efficiency of purging vapor to the intake passage 3.

### Fourth Embodiment

Next, a fourth embodiment of the vaporized-fuel treating apparatus will be described referring to the accompanying drawings.

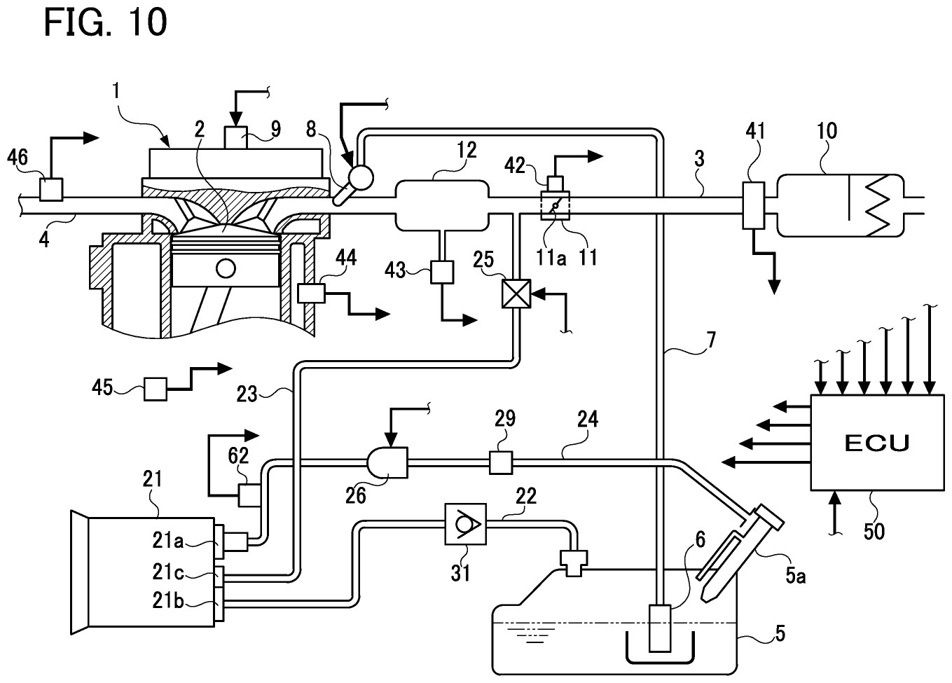

The present embodiment differs from the third embodiment in the structure of the vaporized-fuel treating apparatus and the contents of pump downstream pressure control. FIG. 10 is a schematic diagram showing an engine system in the present embodiment. In this embodiment, instead of the tank internal pressure sensor 63 provided in the fuel tank 5 in the third embodiment, a vapor temperature sensor 62 is provided in the atmospheric-air passage 24 between the canister 21 and the purge pump 26.

In the present embodiment, as one example, the ECU 50, the airflow meter 41, the intake pressure sensor 43, the vapor temperature sensor 62 constitute a pressure limiting unit in the present disclosure.

### (Pump Downstream Pressure Control)

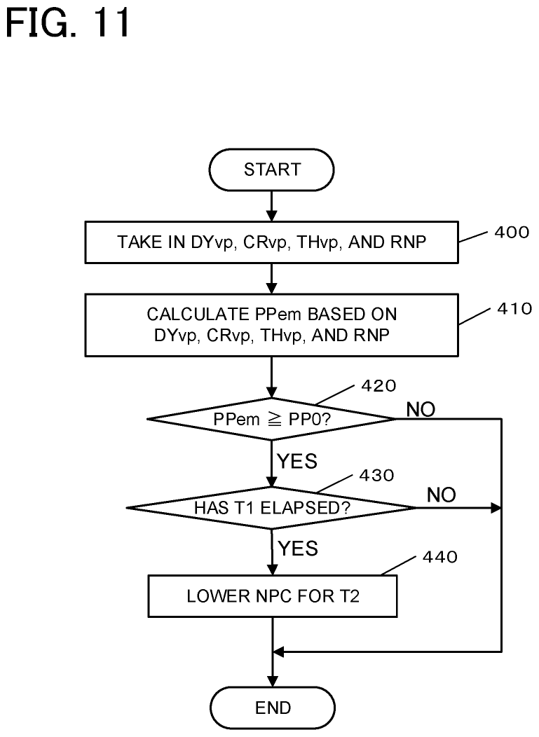

The pump downstream pressure control will be described below. FIG. 11 is a flowchart showing contents of this control. The ECU 50 executes this routine periodically at predetermined time intervals.

When the processing enters this routine, in step 400, the ECU 50 takes in a controlled opening degree DYvp of the purge valve 25, a vapor concentration CRvp, a vapor temperature THvp, and an actual pump rotation number RNP of the purge pump 26. The ECU 50 can calculate the vapor concentration CRvp based on a detected intake amount, a detected intake pressure, and others.

In step 410, the ECU 50 calculates an estimated pump downstream pressure PPem based on the controlled opening degree DYvp, the vapor concentration CRvp, the vapor temperature THvp, and the actual pump rotation number RNP by referring to a four-dimensional map that has been set in advance. In the present embodiment, the estimated pump downstream pressure PPem is calculated because the tank internal pressure sensor 63 is absent.

In step 420, the ECU 50 determines whether or not the estimated pump downstream pressure PPem is equal to or larger than a predetermined value PP0 (e.g., 3 kPa). If YES in step 420, the ECU 50 advances the processing to step 430. If NO in step 420, the ECU 50 temporarily stops subsequent processing.

In step 430, the ECU 50 determines whether or not a predetermined period T1 (e.g., 60 seconds) has elapsed from the time when the determination in step 420 is completed. If YES in step 430, the ECU 50 advances the processing to step 440. If NO in step 440, the ECU 50 temporarily stops subsequent processing.

In step 440, the ECU 50 lowers the upper-limit pump rotation number NPC for a predetermined period T2 (e.g., 10 seconds). The ECU 50 can lower the upper-limit pump rotation number NPC for example from 40000 rpm to 20000 rpm. Then, the ECU 50 temporarily stops the processing.

According to the foregoing control, different from the control in the first embodiment, the ECU 50 is configured to calculate the vapor concentration (i.e., the purge air/fuel ratio) CRvp based on a deviation of an air-fuel ratio feedback correction value calculated from an oxygen concentration Ox detected by the oxygen sensor 46, and others, and also estimate the pressure on a downstream side of the purge pump 26 (i.e., the estimated pump downstream pressure PPem) based on the calculated vapor concentration CRvp, the controlled opening degree DYvp of the purge valve 25 that is currently controlled, and the detected vapor temperature THvp, and reduce the number of rotations of the purge pump 26 (i.e., the upper-limit pump rotation number NPC) when the estimated pump downstream pressure PPem is about to exceed the withstanding pressure of the fuel tank 5 for the predetermined period. Furthermore, since the check valve 31 is provided in the vapor passage 22, the tank internal pressure PT is prevented from increasing even if the pump downstream pressure PP rises.

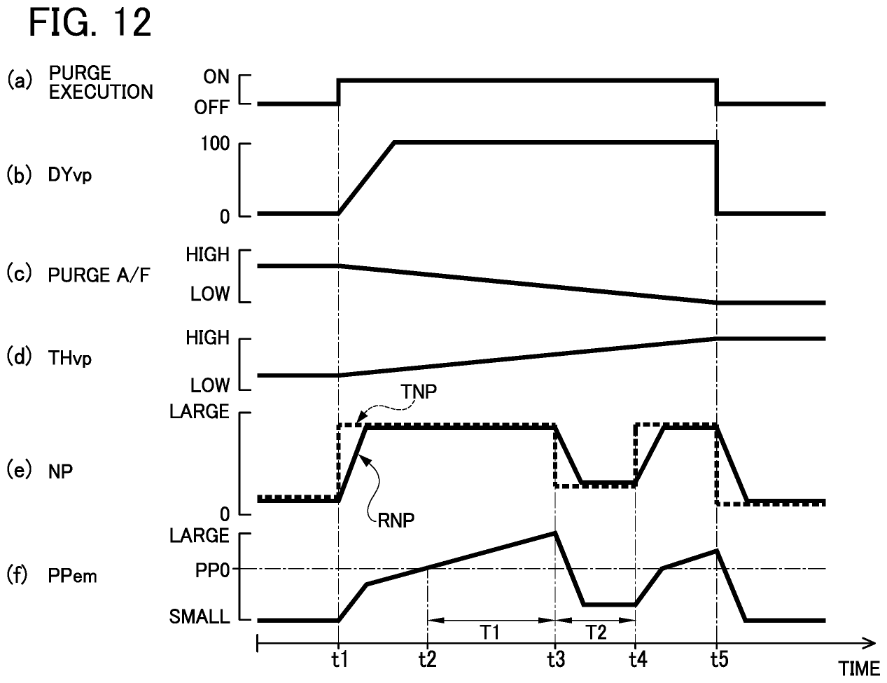

Herein, FIG. 12 is a time chart showing one example of behaviors of various parameters related to the foregoing control. In FIG. 12, a graph (a) indicates purge execution, a graph (b) plots the controlled opening degree DYvp of the purge valve 25, a graph (c) shows a purge air/fuel ratio (A/F), a graph (d) denotes the vapor temperature THvp, a graph (e) shows the pump rotation number NP, and a graph (f) denotes the estimated pump downstream pressure PPem. In the graph (e) of FIG. 12, a thick line indicates the actual pump rotation number RNP and a thick broken line indicates the target pump rotation number TNP.

In FIG. 12, when the purge execution is started, that is, from OFF to ON, at time t1 as shown in the graph (a), the controlled opening degree DYvp of the purge valve 25 starts to increase toward a full open degree (100%) as shown in the graph (b), the purge A/F starts to decrease as shown in the graph (c), the vapor temperature THvp starts to increase as shown in the graph (d), the pump rotation number NP (both the actual pump rotation number RNP and the target pump rotation number TNP) increases as shown in the graph (e), and the estimated pump downstream pressure PPem starts to increase as shown in the graph (f).

When the estimated pump downstream pressure PPem exceeds a predetermined value PP0 at time t2 as shown in the graph (f) and then a predetermined period T1 is elapsed, the pump rotation number NP (both the actual pump rotation number RNP and the target pump rotation number TNP) decreases as shown in the graph (e). Subsequently, while the pump rotation number NP (both the actual pump rotation number RNP and the target pump rotation number TNP) is maintained at the predetermined value for the predetermined period T2, the estimated pump downstream pressure PPem decreases below the predetermined value PP0 as shown in the graph (f). Thereafter, at time t4, the pump rotation number NP (both the actual pump rotation number RNP and the target pump rotation number TNP) is increased again as shown in the graph (e). When the purge execution is then terminated at time t5 as shown in the graph (a), the pump rotation number NP (both the actual pump rotation number RNP and the target pump rotation number TNP) decreases again as shown in the graph (e). Along with this, the estimated pump downstream pressure PPem decreases below the predetermined value PP0 as shown in the graph (f). In this manner, even without the pressure sensor for detecting the pump downstream pressure PP, the ECU 50 configured to calculate the estimated pump downstream pressure PPem and control the number of rotations of the purge pump 26 based on the calculated pressure PPem can decrease the pump downstream pressure PP, thereby enabling reduction of the internal pressure acting on the fuel tank 5.

### (Operations and Effects of Vaporized-Fuel Treating Apparatus)

According to the vaporized-fuel treating apparatus in the present embodiment described above, the vapor concentration CRvp is calculated based on the detected operating state (i.e., a detection value of the oxygen sensor 46) and also the pressure on the downstream side of the purge pump 26 (i.e., the estimated pump downstream pressure PPem) is estimated based on the calculated vapor concentration CRvp, the controlled opening degree DYvp of the purge valve 25 being currently controlled, and the detected vapor temperature THvp. When the estimated pump downstream pressure PPem is about to exceed the withstanding pressure of the fuel tank 5, the the number of rotations of the purge pump 26 (i.e., the pump rotation number NP) is reduced to limit the pump downstream pressure PP from exceeding the withstanding pressure of the fuel tank 5. Accordingly, the vaporized-fuel treating apparatus in which the purge pump 26 is provided in the atmospheric-air passage 24 for drawing atmospheric air into the canister 21 can enhance the performance of purging vapor while preventing deformation of the fuel tank 5 communicating with the downstream side of the purge pump 26 due to the internal pressure of the fuel tank 5. In other words, both effects; prevention of deformation of the fuel tank 5 due to internal pressure thereof and enhancement of vapor purging performance can be satisfied.

According to the structure in the present embodiment, furthermore, even when the pump downstream pressure PP is excessive, this pressure is limited by the check valve 31 from acting on the fuel tank 5. Thus, the vaporized-fuel treating apparatus can increase the pressure in a piping system communicating with the downstream side of the purge pump 26 without causing deformation of the fuel tank 5 due to its internal pressure and thus enhance the efficiency of purging vapor to the intake passage 3.

### Fifth Embodiment

Next, a fifth embodiment of the vaporized-fuel treating apparatus will be described referring to the accompanying drawings.

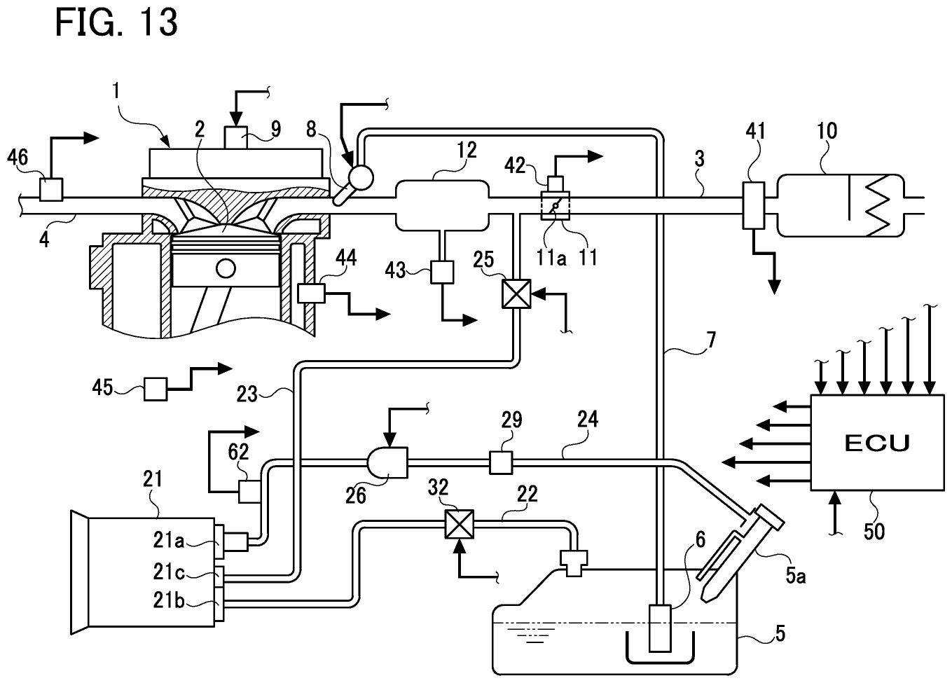

The present embodiment differs from the third embodiment in the structure of the vaporized-fuel treating apparatus and the contents of pump downstream pressure control. FIG. 13 is a schematic diagram showing an engine system in the present embodiment. In this embodiment, instead of the check valve 31 provided in the vapor passage 22 in the fourth embodiment, a shutoff valve 32 is provided in the vapor passage 22. This shutoff valve 32 is configured to electrically open and close.

In the present embodiment, as one example, the ECU 50, the shutoff valve 32, the airflow meter 41, the intake pressure sensor 43, and the vapor temperature sensor 62 constitute a pressure limiting unit in the present disclosure.

### (Pump Downstream Pressure Control)

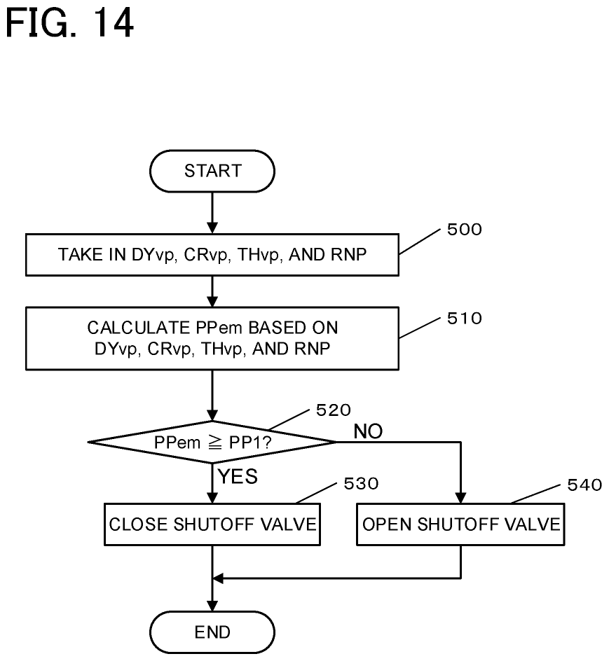

The pump downstream pressure control will be described below. FIG. 14 is a flowchart showing contents of this control. The ECU 50 executes this routine periodically at predetermined time intervals.

When the processing enters this routine, in step 500, the ECU 50 takes in a controlled opening degree DYvp of the purge valve 25, a vapor concentration CRvp, a vapor temperature THvp, and an actual pump rotation number RNP of the purge pump 26. The ECU 50 can calculate the vapor concentration CRvp based on a detection value obtained by the oxygen sensor 46 in a similar manner to the above embodiment.

In step 510, the ECU 50 calculates an estimated pump downstream pressure PPem based on the controlled opening degree DYvp, the vapor concentration CRvp, the vapor temperature THvp, and the actual pump rotation number RNP by referring to a four-dimensional map that has been set in advance. In the present embodiment, the estimated pump downstream pressure PPem is thus calculated because the tank internal pressure sensor 63 is absent.

In step 520, the ECU 50 determines whether or not the estimated pump downstream pressure PPem is equal to or larger than a first predetermined value PP1 (e.g., 8 kPa). If YES in step 520, the ECU advances the processing to step 530. If NO in step 520, the ECU 50 shifts the processing to step 540.

In step 530, the ECU 50 causes the shutoff valve 32 to close and temporarily stops subsequent processing. Accordingly, communication between the canister 21 and the fuel tank 5 is blocked.

In step 540, on the other hand, the ECU 50 causes the shutoff valve 32 to open and then temporarily stops subsequent processing. Thus, communication between the canister 21 and the fuel tank 5 is established.

According to the foregoing control, the ECU 50 is configured to calculate the vapor concentration CRvp based on a detected intake amount, a detected intake pressure, and others, and also estimate the pressure on a downstream side of the purge pump 26 (i.e., the estimated pump downstream pressure PPem) based on the calculated vapor concentration CRvp, the controlled opening degree DYvp of the purge valve 25 that is currently controlled, the detected vapor temperature THvp, and the actual pump rotation number RNP of the purge pump 26 that is currently controlled, and cause the shutoff valve 32 to close if the estimated pump downstream pressure PPem is about to exceed the withstanding pressure of the fuel tank 5.

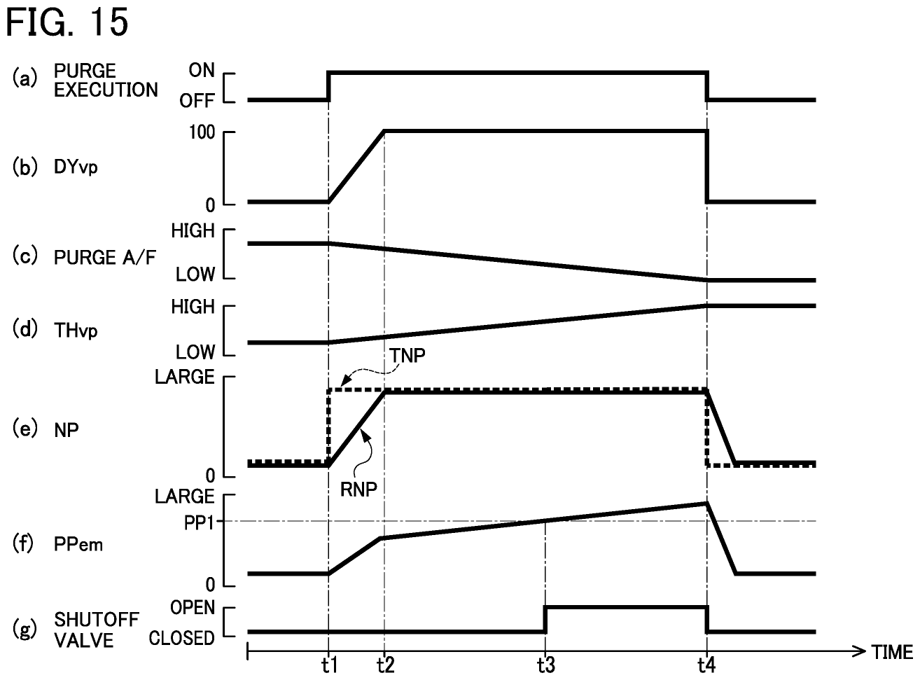

Herein, FIG. 15 is a time chart showing one example of behaviors of various parameters related to the foregoing control. In FIG. 15, a graph (a) indicates purge execution, a graph (b) plots the controlled opening degree DYvp of the purge valve 25, a graph (c) shows a purge air/fuel ratio (A/F), a graph (d) denotes the vapor temperature THvp, a graph (e) shows the pump rotation number NP, a graph (f) denotes the estimated pump downstream pressure PPem, and a graph (g) shows an open/closed state of the shutoff valve 32. In the graph (e), a thick line indicates the actual pump rotation number RNP and a thick broken line indicates the target pump rotation number TNP.

In FIG. 15, when the purge execution is started at time t1 as shown in the graph (a), the controlled opening degree DYvp of the purge valve 25 starts to increase toward a full open degree (100%) as shown in the graph (b), the purge A/F starts to decrease as shown in the graph (c), the vapor temperature THvp starts to increase as shown in the graph (d), the pump rotation number NP (both the actual pump rotation number RNP and the target pump rotation number TNP) increases as shown in the graph (e), and the estimated pump downstream pressure PPem starts to increase as shown in the graph (f). At that time, the controlled opening degree DYvp and the pump rotation number NP (i.e., the actual pump rotation number RNP) increase to respective upper-limit values during a period from time t1 to time t2 and then become constant. Further, the estimated pump downstream pressure PPem increases sharply during a period between time t1 to time t2 and thereafter increases gently. Subsequently, at time t3, when the estimated pump downstream pressure PPem exceeds the first predetermined value PP1 as shown in the graph (f), the shutoff valve 32 is opened as shown in the graph (g). At time t4, thereafter, the purge execution is terminated as shown in the graph (a), the controlled opening degree DYvp becomes 0 as shown in the graph (b), the pump rotation number NP (both the actual pump rotation number RNP and the target pump rotation number TNP) decreases as shown in the graph (e), and the shutoff valve 32 is closed as shown in the graph (g). Accordingly, the estimated pump downstream pressure PPem starts to decrease below the first predetermined value PP1 as shown in the graph (f).

### (Operations and Effects of Vaporized-Fuel Treating Apparatus)

According to the vaporized-fuel treating apparatus in the present embodiment described above, the vapor concentration CRvp is calculated based on the detected operating state (i.e., an intake amount and an intake pressure) and also the pump downstream pressure (i.e., the estimated pump downstream pressure PPem) is estimated based on the calculated vapor concentration CRvp, the controlled opening degree DYvp of the purge valve 25 being currently controlled, the detected vapor temperature THvp, and the actual pump rotation number RNP of the purge pump 26 being currently controlled. When the estimated pump downstream pressure PPem is about to exceed the withstanding pressure of the fuel tank 5, the shutoff valve 32 is closed, thereby blocking the pump downstream pressure PP from transmitting to the fuel tank 5. Therefore, the vaporized-fuel treating apparatus in which the purge pump 26 is provided in the atmospheric-air passage 24 for drawing atmospheric air into the canister 21 can enhance the performance of purging vapor while preventing deformation of the fuel tank 5 communicating with the downstream side of the purge pump 26 due to the internal pressure of the fuel tank 5. In other words, both effects; prevention of deformation of the fuel tank 5 due to internal pressure thereof and enhancement of vapor purging performance can be satisfied.

The present disclosure is not limited to each of the forgoing embodiments and may be embodied in other specific forms without departing from the essential characteristics thereof.

In each of the foregoing embodiments, in the engine system provided with no supercharger, the vaporized-fuel treating apparatus is configured to bring the purge passage 23 into communication with the intake passage 3 downstream of the throttle valve 11a to purge vapor thereto. As an alternative, in an engine system provided with a supercharger, the vaporized-fuel treating apparatus may be configured to bring a purge passage into communication with an intake passage upstream of a throttle valve and downstream of an airflow meter to purge vapor thereto.

### INDUSTRIAL APPLICABILITY

The present disclosure is applicable to an engine system provided with a vaporized-fuel treating apparatus.

### REFERENCE SIGNS LIST

1 Engine
3 Intake passage
5 Fuel tank
21 Canister
22 Vapor passage (Vaporized fuel passage)
23 Purge passage
24 Atmospheric-air passage
25 Purge valve
26 Purge pump
27 Bypass passage (Pressure limiting unit)
28 Bypass valve (Pressure limiting unit)
31 Check valve (Pressure limiting unit)
32 Shutoff valve (Pressure limiting unit)
41 Airflow meter (Operating-state detecting unit, Pressure limiting unit)
43 Intake pressure sensor (Operating-state detecting unit, Pressure limiting unit)
50 ECU (Controller, Pressure limiting unit)
61 Pump downstream pressure sensor (Pump downstream pressure detecting unit, Pressure limiting unit)
62 Vapor temperature sensor (Vaporized fuel temperature detecting unit, Pressure limiting unit)
63 Tank internal pressure sensor (Tank internal pressure detecting unit, Pressure limiting unit)
PP Pump downstream pressure
PPem Estimated pump downstream pressure
TNP Target pump rotation number
RNP Actual pump rotation number
THvp Vapor temperature
DYvp Controlled opening degree
CRvp Vapor concentration
PT Tank internal pressure

What is claimed is:

1. A vaporized-fuel treating apparatus comprising:
a canister configured to collect vaporized fuel generated in a fuel tank;
a vaporized fuel passage configured to introduce the vaporized fuel from the fuel tank to the canister;
a purge passage configured to direct and purge the vaporized fuel collected in the canister to an intake passage of an engine;
a purge valve configured to open and close the purge passage;
an atmospheric-air passage configured to draw atmospheric air into the canister;
a purge pump provided in the atmospheric-air passage and configured to supply pressurized air to the canister;
a controller configured to control at least the purge valve and the purge pump to purge the vaporized fuel from the canister to the intake passage; and
a pressure limiting unit configured to limit pressure downstream of the purge pump, the pressure acting on the fuel tank, from exceeding withstanding pressure of the fuel tank while the controller controls the purge valve and the purge pump to purge the vaporized fuel from the canister to the intake passage.

2. The vaporized-fuel treating apparatus according to claim 1, wherein
the pressure limiting unit includes:
the controller;
a bypass passage provided in the atmospheric-air passage and configured to detour around the purge pump;
a bypass valve configured to open and close the bypass passage; and
a pump downstream pressure detecting unit configured to detect the pressure downstream of the purge pump, and
the controller is configured to control a number of rotations of the purge pump to limit the detected downstream pressure from exceeding the withstanding pressure.

3. The vaporized-fuel treating apparatus according to claim 2, wherein the controller is configured to cause the bypass valve to open when the detected downstream pressure exceeds the withstanding pressure.

4. The vaporized-fuel treating apparatus according to claim 1, wherein
the pressure limiting unit includes:
the controller;
a bypass passage provided in the atmospheric-air passage configured to detour around the purge pump;
a bypass valve configured to open and close the bypass passage;
an operating-state detecting unit configured to detect an operating state of the engine; and
a vaporized fuel temperature detecting unit configured to detect a temperature of the vaporized fuel,
the controller is configured to:
calculate concentration of the vaporized fuel based on the detected operating state;
calculate a target number of rotations of the purge pump based on the calculated concentration of the vaporized fuel, an opening degree of the purge valve that is currently controlled, and the detected temperature of the vaporized fuel; and
cause the bypass valve to open when the purge pump is in deceleration and an actual number of rotations of the purge pump is larger than the calculated target number of rotations.

5. The vaporized-fuel treating apparatus according to claim 1, wherein
the pressure limiting unit includes the controller and a tank internal pressure detecting unit configured to detect an internal pressure of the fuel tank, and
the controller is configured to reduce the number of rotations of the purge pump when the detected internal pressure is about to exceed the withstanding pressure.

6. The vaporized-fuel treating apparatus according to claim 5, wherein the pressure limiting unit further includes a check valve provided in the vaporized fuel passage and configured to allow a flow of gas from the fuel tank to the canister and block a flow of gas from the canister to the fuel tank.

7. The vaporized-fuel treating apparatus according to claim 1, wherein
the pressure limiting unit includes:
the controller;
an operating-state detecting unit configured to detect an operating state of the engine; and
a vaporized fuel temperature detecting unit configured to detect a temperature of the vaporized fuel,
the controller is configured to:
calculate concentration of the vaporized fuel based on the detected operating state;
estimate pressure downstream of the purge pump based on the calculated concentration of the vaporized fuel, an opening degree of the purge valve that is currently controlled, and the detected temperature of the vaporized fuel; and
decrease a number of rotations of the purge pump when the estimated downstream pressure is about to exceed the withstanding pressure.

8. The vaporized-fuel treating apparatus according to claim 7, wherein the pressure limiting unit further includes a check valve provided in the vaporized fuel passage and configured to allow a flow of gas from the fuel tank to the canister and block a flow of gas from the canister to the fuel tank.

9. The vaporized-fuel treating apparatus according to claim 1, wherein
the pressure limiting unit includes:
the controller;
a shutoff valve configured to open and close the vaporized passage;
an operating-state detecting unit configured to detect an operating state of the engine; and
a vaporized fuel temperature detecting unit configured to detect a temperature of the vaporized fuel,
the controller is configured to:
calculate concentration of the vaporized fuel based on the detected operating state;
estimate pressure downstream of the purge pump based on the calculated concentration of the vaporized fuel, an opening degree of the purge valve that is currently controlled, the detected temperature of the vaporized fuel, and a number of rotations of the purge pump that is currently controlled; and
cause the shutoff valve to close when the estimated downstream pressure is about to exceed the withstanding pressure.
